(19) United States
(12) Patent Application Publication
(10) Pub. No.: US 2008/0186709 A1
(43) Pub. Date: Aug. 7, 2008

(54) Variable Reflector Device

(75) Inventors: Stein Kuiper, Eindhoven (NL); Bernardus Hendrikus Wilhelmus Hendriks, Eindhoven (NL); Lingli Wang, Eindhoven (NL); Christoph Gerard August Hoelen, Eindhoven (NL); Johannes Petrus Maria Ansems, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,603

(22) PCT Filed: Jan. 9, 2006
(86) PCT No.: PCT/IB06/50072

§ 371 Date: Jul. 10, 2007

(30) Foreign Application Priority Data
Jan. 14, 2005 (EP) 05100200.4

(51) Int. Cl. F21S 8/00

(52) U.S. Cl. 362/277

(57) ABSTRACT

A variable reflector device, comprising a reflector (6) arranged to direct light from a light source (7) and a casing (5) containing the reflector (6), a portion of said casing (5) being transparent to light directed by the reflector (6). The reflector (6) is formed by a meniscus (2) at an interface between two immiscible fluids (3,4) contained in said casing (5). According to this design, the spatial distribution of light from the light source is changeable by changing the shape of the meniscus between the two fluids. Since a change in shape of the meniscus is effected by a displacement of fluids rather than of mechanical parts, the change in reflector shape can generally be performed faster and with less energy consumption than is the case with previously known designs. Further, a meniscus between two immiscible fluids can, due to the nature of fluids, take on several different shapes, which is not the case when a solid body reflector is utilised.

The present invention relates to a variable reflector device, comprising a reflector arranged to direct light from a light source and a casing containing the reflector, a portion of said casing being transparent to light directed by the reflector and a lighting device including such a variable reflector device.

Lighting is an important factor in the perception of a space, whether it will be a living room or a public space. With a proper spatial distribution and a suitable intensity of the irradiated light, a desired atmosphere in the particular space can be created. One way of achieving this can be to position a large number of light sources with individually controllable light intensity. Another way of achieving the same object is to have a smaller number of light sources, from which the spatial light distribution can be varied. As light sources, LEDs have become increasingly popular since they are compact, energy efficient and operate at low temperature.

In U.S. Pat. No. 6,561,678, a variable focus indirect lighting fixture is disclosed. This lighting fixture comprises a pair of first reflectors each substantially surrounding a light source, and a second variable focus reflector, positioned in front of said first reflectors. By varying the position of the centre line of the second reflector, the focus of the light output from the lighting fixture can be varied. The variation can either take place manually with a screw, or automatically with, for example, an electric motor.

To be able to vary the spatial light distribution using a number of these lighting devices, one would thus have to either manually alter the reflector shape of each individual lighting device or install an individually controllable electrical motor for each lighting device. Hence, one would either be limited to very slow and infrequent manual variations in spatial light distribution, or be forced to make a relatively large initial investment with individually controllable electric motors or similar for every lighting device. Furthermore, the use of moving mechanical parts for facilitating the variation of spatial light distribution makes these lighting devices susceptible to wear and failure due to mechanical malfunction.

In view of the above-mentioned and other drawbacks of the prior art, a general object of the present invention is to provide an improved variable reflector device.

An object of the present invention is to enable rapid alterations of reflector shape.

Another object of the present invention is to reduce the risk of mechanical failure of lighting devices with variable spatial light distribution.

A further object of the present invention is to enable a relatively inexpensive lighting device with variable spatial light distribution.

These and other objects are achieved by a variable reflector device, comprising a reflector arranged to direct light from a light source and a casing containing the reflector, a portion of said casing being transparent to light directed by the reflector, wherein the reflector is formed by a meniscus at an interface between two immiscible fluids contained in said casing.

According to this design, the spatial distribution of light from the light source is changeable by changing the shape of the meniscus between the two fluids. Preferably, the light source comprises at least one LED. However, any light source having moderate working temperatures can be used in connection with the variable reflector device.

Since a change in shape of the meniscus is effected by a displacement of fluids rather than of mechanical parts, the change in reflector shape can generally be performed faster and with less energy consumption than is the case with previously known designs.

Further, a meniscus between two immiscible fluids can, due to the nature of fluids, take on several different shapes, which is not the case when a solid body reflector is utilised.

It is also understood that a variable reflector in the form of a meniscus at the interface between two immiscible fluids can be more inexpensive than a mechanical construction involving a metallic reflector, especially when an electrical motor is needed to vary the shape of the metallic reflector.

The term “light” is understood to include both visible electromagnetic radiation and other wavelengths of electromagnetic radiation.

A fluid is a substance, which alters its shape in response to any force and which tends to flow or to conform to the outline of the chamber in which it may be contained. The term fluid thus includes gases, liquids, vapours and mixtures of solids and liquids, said mixtures being capable of flow.

The term “immiscible” is used to describe fluids capable of forming a meniscus.

According to one embodiment, the variable reflector device further comprises means for altering the wettability of the internal surface of the casing at portions of the perimeter of the meniscus.

By varying the wettability in the vicinity of the perimeter of the meniscus, the shape and position of the meniscus between the two fluids, i.e. the shape of the reflector, can be changed, given that the two fluids have different wetting properties.

Preferably, said means for altering the wettability utilise electrowetting.

By applying a voltage between one of the fluids and a suitably positioned electrode, the wetting angle and the position of the meniscus can be altered and hence the reflector shape varied. The principles and advantages of electrowetting used for lenses and optical switches are well known and the same basic mechanisms of electrowetting are applicable also for the use of electrowetting in devices according to the present invention.

Further advantages can be obtained with a reflector device, wherein the volumes of the fluids contained in the casing are allowed to vary.

Although a multitude of reflector shapes can be formed while keeping the volumes of the fluids contained in the casing constant, even more shapes can be formed with the extra degree of freedom obtained by allowing the volumes of the fluids contained in the casing to vary.

According to another embodiment, the variable reflector device further comprises a transportation channel and flow control means for changing the reflector shape by transportation of the fluids. Such fluid transportation alters the shape and/or position of the meniscus, thus offering an alternative way of controlling the reflector of the device. If only flow control is used to control the meniscus, other fluids than those suitable for electrowetting can be used. However, by combining controlled transportation of fluids with controllable variation in the wettability of the internal surface of the casing, such as electrowetting, more degrees of freedom in changing the shape of the reflector are introduced.

The reflector device can further comprise transportation channels to external reservoirs to and from which the fluids can be transported by the flow control means. With such external reservoirs the volumes of the fluids in the casing and hence the shape of the reflector can be varied over a very wide range.

The flow control means can be provided in the form of a pump, e.g. an electrowetting pump or a ferrofluidic pump.

Furthermore, the reflector can be formed by means of a metal liquid-like film arranged at the meniscus.

The use of fine metallic particles to form a metal liquid-like film (MELLF) at the interface between two liquids or on top of a liquid is described in the literature (APPLIED OPTICS/Vol. 42, No. 10/1 April 2003). For example, a large number of metallic nanoparticles coated with organic ligands can be spread out on a liquid substrate, where they self-assemble to give optical quality reflective surfaces.

By forming the reflector with a MELLF arranged at the meniscus, a high quality reflector can be formed without having to take into account the indices of refraction of the fluids. The introduction of a MELLF is, of course, by no means necessary for being able to form a reflector at the meniscus between two fluids, but once again the freedom of the engineer designing a reflector device for a particular application is greatly increased.

In another embodiment of the variable reflector device, at least a part of the perimeter of the meniscus is fixedly located by a discontinuity in at least one characteristic of the internal surface of the casing. By selecting suitable fluids for the variable reflector device and designing the casing so that there is a discontinuity in certain characteristics of the internal surface of the casing, at least a part of the perimeter of the meniscus can be fixedly located at the position of said discontinuity. The discontinuity could, for example, be an abrupt change in the wettability or a sudden change in the geometry of the surface. That the meniscus is fixedly located at a certain position of the internal surface of the casing means that a relatively large force is needed to displace the meniscus from said position. For example, the menicus can be moved away from a fixedly located position by a sufficiently large change in volumes of the fluids in the casing.

The possibility to fixedly locate the position of the perimeter of the meniscus by a discontinuity opens up possibilities for engineering complex reflector shapes.

These and other aspects of the present invention will now be described in more detail, with reference to the appended drawings showing currently preferred embodiments of the invention.

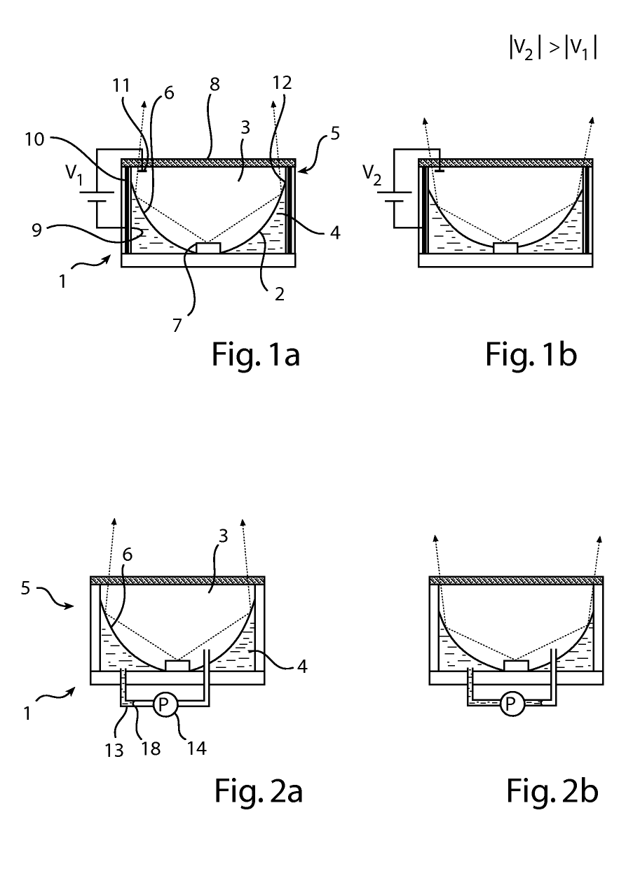

FIG. 1a is a schematic view of a lighting device provided with a light source and a reflector device according to a first embodiment of the present invention, where the reflector device is in a first state.

FIG. 1b is a schematic view of the device in FIG. 1a in a second state.

FIG. 2a is a schematic view of a lighting device provided with a light source and a reflector device according to a second embodiment of the present invention, where the reflector device is in a first state.

FIG. 2b is a schematic view of the device in FIG. 2a in a second state.

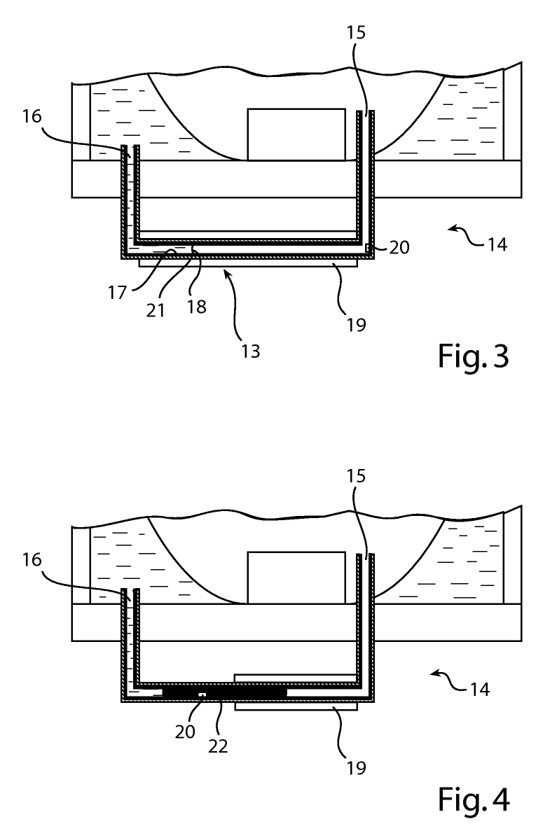

FIG. 3 is a schematic view of an electrowetting pump.

FIG. 4 is a schematic view of an electrowetting pump with a “water slug”.

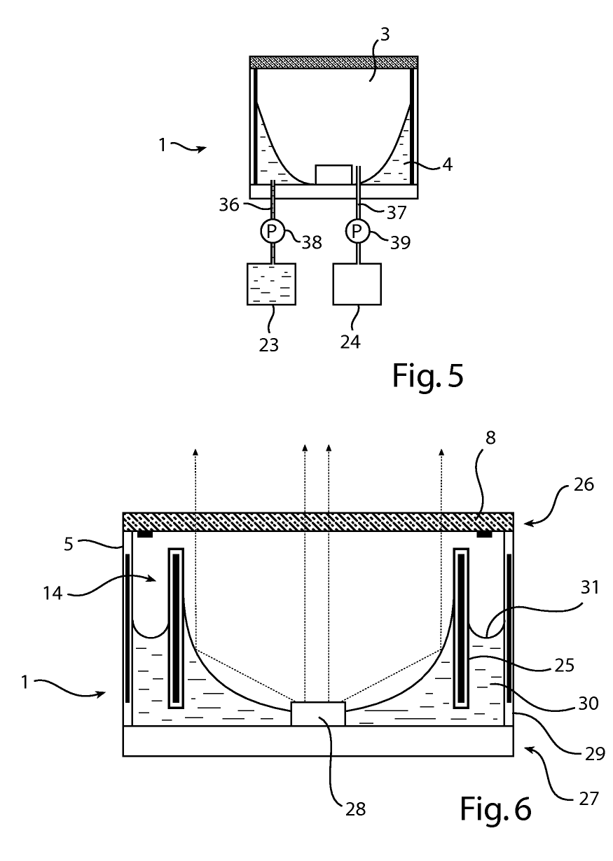

FIG. 5 is a schematic view of a lighting device provided with a light source and a reflector device according to a third embodiment of the present invention.

FIG. 6 is a schematic view of a lighting device provided with a light source and a reflector device according to a fourth embodiment of the present invention.

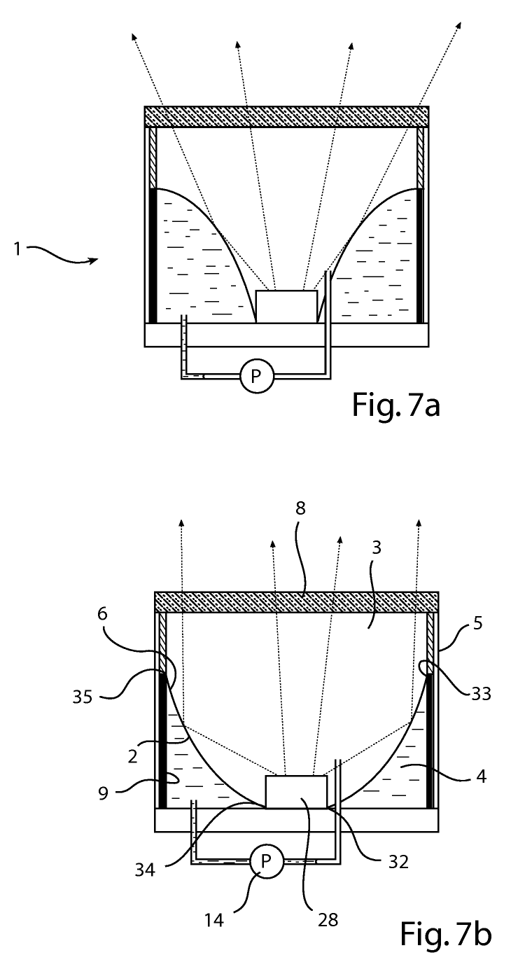

FIG. 7a is a schematic view of a lighting device provided with a light source and a reflector device according to a fifth embodiment of the present invention, where the reflector device is in a first state.

FIG. 7b is a schematic view of the device in FIG. 7a in a second state.

FIGS. 1a-b schematically show a lighting device 1 with a variable reflector device according to a first embodiment of the present invention where a meniscus 2 at an interface between two fluids 3,4 contained in a casing 5 form a reflector 6, which is arranged to direct light from a light source 7 through a window 8 in the casing 5. In this example, the two fluids are water (n=1.34) and oil (n=1.70), the casing is cylindrically shaped and the internal surface of the casing is partly coated with an insulative hydrophobic coating 9. Since the difference in refractive indices between water and oil is rather large, the reflector device can be designed relying on total internal reflection (TIR). In this case, with water and oil, the critical angle for TIR is 52°.

In order to improve the reflectance of the reflector device and to facilitate the use of fluids with a smaller difference in refractive indices, a metal liquid-like film (MELLF) can be arranged at the meniscus between the two fluids.

Electrodes 10,11 are arranged to allow application of a voltage over the insulating hydrophobic surface coating 9 on the internal surface of the casing 5. One electrode 11 is thus in contact (direct contact or capacitively coupled) with the water 3 and the other—the casing electrode 10—is positioned so that the electric field is mainly present in the hydrophobic coating 9.

When no voltage is applied over the electrodes 10,11, the equilibrium conditions are determined by the influence of external forces, such as gravitation, and the material properties of the fluids and the internal surface of the casing, respectively. When a voltage is applied, an electrostatic term (˜CV², where C is the capacitance of the parallel plate capacitor formed by the water, the hydrophobic insulator and the casing electrode) is added to the energy balance. This electrostatic term alters the equilibrium conditions at the three-part contact line 12 between the fluids 3,4 and the hydrophobic coating 9 at the internal surface of the casing 5, making it energetically more favourable for the water to come into contact with more of the hydrophobic coating 9. Hence the contact line 12 is moved and the reflector shape thereby altered.

FIG. 1a shows a first state when a certain voltage is applied and FIG. 1b shows a second state when a higher voltage is applied. In these two states, the reflector device reflects light with two different spatial distributions as indicated in the figures.

The actual voltage difference required to enable a substantial change in reflector shape depends on the material properties of the fluids and the hydrophobic material on the internal surface of the casing, as well as on the distance between the casing electrode and the internal surface of the casing. The smaller this distance is, the lower the voltage is, which is required to obtain a certain electric field between the two electrodes (the water 3 and the casing electrode 10). Even though it is possible to have the casing electrode 10 arranged on the outside of the casing 5, it is favourable to have the electrode arranged on the internal surface of the casing, covered with a hydrophobic insulator 9. Thereby low-voltage control of the reflector shape is facilitated. It thus follows that the hydrophobic insulator 9 should be made as thin as possible, while avoiding electrostatic breakdown in the hydrophobic insulator 9.

Additional casing electrodes can be added to enable other alterations of the reflector shape.

In FIGS. 2a-b, a lighting device 1 comprising a reflector device according to a second embodiment of the present invention is shown. Here, the electrodes of the first embodiment have been removed and a transportation channel 13 and a flow control means 14 in the form of a pump have been added. The channel 13 and the pump 14 are arranged to change the volumes of the fluids 3,4 contained in the casing 5. A meniscus 18 is formed at the interface between the fluids 3,4 inside the channel 13. In this example, an increase in the volume of water 3 contained in the casing 5 results in an equally sized decrease in the volume of oil 4 contained in the casing 5. Consequently, the shape of the reflector 6 is changed. Such a change in reflector shape is illustrated in FIGS. 2a-b.

The extent to which the reflector shape can be varied in an arrangement according to this embodiment is mainly determined by the volume of the transportation channel 13, since water 3 should not be pumped into the oil 4 and vice versa.

Pumping of the fluids can be done in many ways, for example by a mechanical pump, an electrowetting pump or a ferrofluidic pump. As an example of a suitable pump, an electrowetting pump is shown in FIG. 3. Here, the pump 14 is provided as a channel 13 with one connection to the “water-side” 15 of the system and one connection to the “oil-side” 16. A hydrophobic electrically insulating coating 17 is applied on the internal surface of the channel 13. Along the channel 13, the water and the oil meet and a meniscus 18 are formed. In the channel 13, there are also two electrodes 19,20. One electrode 20 is arranged to contact the water and one electrode 19 surrounds a portion of the channel. In this way, a voltage can be applied over the hydrophobic coating 17. A change in voltage will, as previously described, result in a change in the energy balance at the contact line 21 between the meniscus and the channel walls and thus result in a movement of the meniscus 18, which is equivalent to a displacement of the fluids.

As mentioned earlier, a large difference in indices of refraction facilitates designing a reflector device relying on TIR. In order to design a robust device, one is also interested in having two fluids with essentially the same densities. For these and other reasons, the selection of fluids is important and the possibilities given by an increased set of fluids to choose from are valuable. As an example, the use of a pump, opens up the possibility to select other fluids than those directly suitable for electrowetting, such as fluorinated oil, which has a very low refractive index, and hydrocarbon oil. The combination of these fluids is not suitable for direct application of electrowetting, since none of the fluids is electro-conductive.

It will be shown, as illustrated in FIG. 4, that it is still possible to use an electrowetting pump for the displacement of these fluids. In the electrowetting pump 14 schematically shown in FIG. 4, a “water slug” 22 is added. It is then this “slug” 22 which is moved by the application of different voltages in the same manner as described in connection to FIG. 3. Moving of the water slug leads to a displacement of the fluids not directly suitable for electrowetting, in this case the fluorinated oil and the hydrocarbon oil.

A third embodiment of a reflector device 1 according to the invention is schematically shown in FIG. 5. Here, two external reservoirs 23,24, each associated with a transportation channel 36,37 and a pump 38,39, have been added, whereby the risk of an inadvertent mixing of the two fluids 3,4 is practically eliminated.

In a fourth embodiment of the reflector device 1 according to the present invention, shown schematically in FIG. 6, the casing 5 comprises a first cylindrical envelope 25, a top side 26 with a window 8 and a bottom side 27 with an LED-socket 28. The first envelope 25 is surrounded by a second cylindrical envelope 29, on which the top side 26 and the bottom side 27 are attached. Between the cylindrical envelopes 25,29, a transportation channel 30 in the shape of a cylindrical shell is formed. Inside this transportation channel, a mensiscus 31 is formed, which can be displaced by, for instance, using an electrowetting pump 14 arranged in the channel 30.

In a fifth embodiment of the reflector device 1 according to the present invention, shown schematically in FIGS. 7a-b the meniscus 2 forming the reflector 6 has a perimeter with a first part 32 encircling the LED-socket 28 and a second part 33 in contact with the internal surface of the casing 5 and positioned closer to the window 8. The meniscus 2 between these parts of the perimeter 32,33 define the reflector 6. In embodiments 1-4, the reflector shape is generally altered by a movement of the second part 33 of the perimeter, while the first part 32 of the perimeter has been essentially fixedly located.

The perimeter of the meniscus can be fixedly located by a discontinuity in one or several characteristics of the internal surface of the casing. In the example illustrated by FIGS. 7a-b, two different ways of fixed location, or “pinning” are shown. The first part 32 of the perimeter encircling the LED-socket 28 is pinned by a sudden change in geometry of the internal surface, in this case a corner 34. The second part 33 of the perimeter is, in this example, pinned by an abrupt change in the wettability of the internal surface. On the LED-side of the position where this part of the perimeter should be located, a hydrophobic coating 9 is applied on the internal surface of the casing 5. From the desired position of the perimeter and up to the window 8, the internal surface of the casing 5 is made hydrophilic. The second part 33 of the perimeter of the meniscus 2 will then be pinned to the line 35 defining abrupt transition from hydrophobic to hydrofilic surface conditions. When the volumes of the fluids 3,4 in the casing 5 are changed by the pump 14, the meniscus shape will change, but the positions of the lines of contact between the meniscus and the internal surface of the casing will remain essentially unchanged. If the force on the lines of contact, resulting from the change in volumes is larger than the pinning force, the contact lines will, of course, be displaced.

The person skilled in the art realises that the present invention by no means is limited to the preferred embodiments described above. On the contrary, many modifications and variations are possible within the scope of the appended claims. For example, the casing containing the reflector, can be shaped in the way most suitable for the particular implementation—it could, for instance, be conically shaped. Furthermore, the reflector may be made rotationally un-symmetrical, so that the light from the light source is not only focussed, but given a desired beam shape.

1. A variable reflector device, comprising a reflector (6) arranged to direct light from a light source (7) and a casing (5) containing the reflector (6), a portion of said casing (5) being transparent to light directed by the reflector (6), characterized in that the reflector (6) is formed by a meniscus (2) at an interface between two immiscible fluids (3,4) contained in said casing (5).

2. A variable reflector device as claimed in claim 1, further comprising means (10,11) for altering the wettability of the internal surface of the casing at portions of the perimeter of the meniscus (2), thereby changing the reflector (6) shape.

3. A variable reflector device as claimed in claim 2, wherein said means (10,11) for altering the wettability utilise electrowetting.

4. A variable reflector device as claimed in claim 1, characterized in that the volumes of the two fluids (3,4) are allowed to vary.

5. A variable reflector device as claimed in claim 4, further comprising at least one transportation channel (13) and at least one flow control means (14) for changing the reflector (6) shape by transportation of the fluids (3,4).

6. A variable reflector device as claimed in claim 5, further comprising at least one transportation channel (36,37) to at least one external reservoir (33,34) to and from which at least one of the fluids (3,4) can be transported by said at least one flow control means (38,39).

7. A variable reflector device as claimed in claim 5, characterized in that the at least one flow control means (14) is provided in the form of a pump, e.g. an electrowetting pump or a ferrofluidic pump.

8. A variable reflector device as claimed in claim 1, characterized in that the reflector (6) is formed by means of a metal liquid-like film arranged at the meniscus (2).

9. A variable reflector device as claimed in claim 1, characterized in that at least a part of the perimeter of the meniscus (2) is fixedly located by a discontinuity in at least one characteristic of the internal surface of the casing (5).

10. A lighting device (1) comprising a light source (7) and a variable reflector device as claim 1.
